(19) United States
(12) Patent Application Publication
(10) Pub. No.: US 2006/0161898 A1
(43) Pub. Date: Jul. 20, 2006

(54) Method and system for project library dependency management

(76) Inventors: Brian Bauman, Austin, TX (US); Jeffrey Alan McAffer, Ottawa (CA); David S. Klein, Georgetown, TX (US); Wassim Melhem, Toronto (CA)

Correspondence Address: Greg Goshorn, P.C., 9600 Escarpment, auite 745-9, AUSTIN, TX, 78749, US

(21) Appl. No.: 11/037,772

(22) Filed: Jan. 18, 2005

(51) Int. Cl. G06F 9/44

(52) U.S. Cl. 717/127

(57) ABSTRACT

Provided is a method and tool for automatically including libraries in a buildpath. While developing a package, a user creates a list of potential libraries in a special classpath container but does not add these libraries to the project manifest. The method tracks the packages used in the project and, once a particular package is used, or referenced, the user is notified if the libraries necessary for that particular package are not in the manifest and will thus not be available at runtime. The user can then add the required library or libraries to the manifest. The user can also set an option so that the tool automatically adds a library to the manifest when the tool detects that the library is required.

### TECHNICAL FIELD

The present invention relates generally to software development and, more specifically, to a method for managing project library dependencies.

### BACKGROUND OF THE INVENTION

In 1999, the OSGi® Alliance, herein after referred to simply as “OSGi,” was initiated to develop an open specification for the delivery of services over local networks and devices. Currently, the OSGi standard is supported by over eighty (80) companies. OSGi was developed to provide services to environments such as homes, cars and offices. Some embedded devices that employ the OSGi specification include, but are not limited to, television set top boxes, service gateways, cable modems, consumer electronic devices, personal computers (PCs), industrial computers and automobiles. A specification, entitled “The OSGi Services Platform, Release 2,” was published in October 2001

The OSGi environment is organized around a “framework” and “bundles.” The OSGi framework provides an execution environment for electronically downloadable services, or bundles. The framework includes a Java runtime engine, life cycle management, data storage, version management and a service registry. Bundles are the primary software components in the OSGi environment. They can contain Java classes and other resources, which provide libraries, services, and applications to end-users of a computing system and to other bundles. Typically, bundles are stored in a standard Zip-based Java file format, or Java Archive (JAR) file.

Currently, the development of OSGi bundles can be tedious. The developer must manage the set of libraries that the bundle depends on. In the OSGi environment, these libraries are typically other OSGi bundles. An OSGi bundle contains a manifest descriptor that declares the packages and other bundles that the OSGi bundle is dependant on. The manifest is used at runtime by the OSGi framework to resolve the OSGi bundle's dependencies. Therefore, the developer must not only set up the proper Java classpath when building the code, but must also insure that the manifest file contains the proper bundle (library) dependencies.

Proper manifest dependencies are crucial for running a bundle under OSGi. If the manifest file is missing a bundle (library) dependency, then the bundle can fail when it is run in the OSGi framework. If the manifest file lists unnecessary bundle dependencies, then at best this may require bundles to be loaded into the OSGi runtime that would not otherwise be there. This is a concern for embedded devices where the goal is to reduce the runtime footprint. At worst, unnecessary dependencies may prevent the bundle from being run if the dependencies do not exist in the targeted runtime.

For the reasons mentioned above, it is not prudent for the developer to add a large set of dependencies to the manifest in the hopes that it will cover all possible requirements. Unfortunately, the only current method to eliminate unnecessary library dependencies requires the developer to examine each class in the project to determine the packages and the respective libraries that have actually been used. The developer then removes from the manifest those dependencies that are not necessary.

### SUMMARY OF THE INVENTION

Provided is a tool for automatically including libraries in a development time classpath, which is referred to throughout the remainder of this document as a “buildpath.” A library is not added to a project manifest until the library is actually referenced in a project. While developing a package, a user creates a list of potential libraries in a special classpath container but does not add these libraries to the project manifest. The tool tracks the packages used in the project and, once a particular package is used, or referenced, the user is notified if the libraries necessary for that particular package are not in the manifest and will thus not be available at runtime. The user can then add the required library or libraries to the manifest. The user can also set an option so that the tool automatically adds a library to the manifest when the tool detects that the library is required.

A user creates a list of libraries that may be needed in a project. A classpath container that includes this list, along with any bundles specified in the manifest, is placed on the buildpath of the project. The tool enables the user to develop and compile the project, using the libraries in the list, without bloating the manifest. In other words, rather than putting actual libraries on a manifest, libraries that potentially may be added to the manifest are specified in the library list. The disclosed tool places a particular library on the manifest only after the tool determines that the library is actually necessary.

Once the user saves project files and initiates the disclosed process, the tool scans the project files to determine which packages and corresponding libraries are referenced in the project files. If a package and corresponding library is on the list of libraries, then either the user is notified that the library must be added to the project manifest or the tool automatically adds the library to the manifest.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary computer architecture that supports an OSGi framework and the claimed subject matter;

FIG. 2 is a block diagram of a project buildpath tool, illustrated in conjunction with various components of the computing architecture of FIG. 1;

FIG. 3 is a flow chart of an exemplary Build Project process that employs the claimed subject matter; and

FIG. 4 is a flow chart detailing a portion of the process of FIG. 3 in more detail.

### DETAILED DESCRIPTION OF THE FIGURES

Although described with particular reference to an OSGi framework, the claimed subject matter can be implemented in any information technology (IT) system in which an efficient build process is desirable. Those with skill in the computing arts will recognize that the disclosed embodiments have relevance to a wide variety of computing environments in addition to those described below. Further, although described with respect to bundles and projects, the claimed subject matter also is applicable to modules, applications or any other type of interdependent computer logic. In other words, the disclosed technology is applicable to any situation in which there is interdependent computer code and a user or developer needs or wants to track the application programming interfaces (APIs) that are actually used.

In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

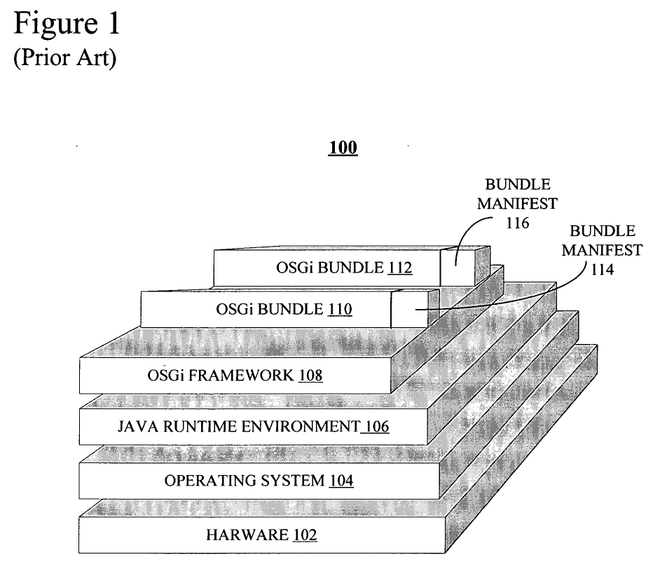

FIG. 1 illustrates an exemplary computing architecture 100 that supports an OSGi framework 108 and the claimed subject matter. System 100 is implemented on a hardware platform 102, which can include, but is not limited to, such computing platforms as television set top boxes, service gateways, cable modems, consumer electronic devices, personal computers (PCs), industrial computers and automobiles. An operating system (OS) 104 manages the resources of hardware 102. Examples of three OSs that support the claimed subject matter include Linux, MacIntosh and the various versions of Windows, all of which, as well as others, should be familiar to those with skill in the computing arts. In this example, OS 104 is supporting a Java runtime environment 106. Java runtime environment 106 supports the Java programming language, which is a product of Sun Microsystems, Inc. of Santa Clara, Calif. Java runtime environment 106 includes a Java runtime engine (not shown) which executes Java programs, Java programs are compiled into byte codes which are interpreted by the Java runtime environment 106 rather then being compiled into native machine code. In this manner, a particular Java program can be written to execute on any hardware platform 102 and OS 104 that includes the Java runtime environment 106.

OSGi framework 108 is designed to operate in Java runtime environment 106. Framework 108 provides the core of the OSGi Service Platform Specification. As explained above in the Background, the OSGi Service Platform Specification was first developed in 1999 to simplify the delivery of services over local networks and devices, industrial computers and automobiles. OSGi framework 108 provides an execution environment for, in this example, electronically downloadable services, or bundles 110 and 112. Framework 108 includes program life cycle management, data storage, program version management and a service registry for bundles 110 and 112. In this example, bundles 110 and 112 are Java applications, including classes, methods and other resources, which provide functions, or “services,” to end-users of computing system 100 and other bundles. Typically, but not necessarily, bundles 110 and 112 are stored in a standard Zip-based Java file format, or Java Archive (JAR) file.

OSGi bundles 110 and 112 include Java classes and other resources which provide functions to end users of system 100 and provide components, or “services,” to other bundles. Bundles typically implement zero or more services. Bundle 110 and 112 can include such things as class files for the Java programming language as well as other data such as, but not limited to, hypertext markup language (HTML) files, help files and icons. Like other OSGI compliant bundles, bundles 110 and 112 each include a manifest file 114 and 116, respectively, which describes the contents of the corresponding bundle 110 or 112 and provides information that the framework 108 requires to correctly install and activate the corresponding bundle 110 or 112. Bundles 110 and 112 also include a special class, or “bundle activator,” (not shown) that provides methods to start and stop the bundle 110 or 112. In addition, bundles 110 and 112 include information, in manifest files 114 and 116, about any resource dependencies the corresponding bundle 110 or 112 may have.

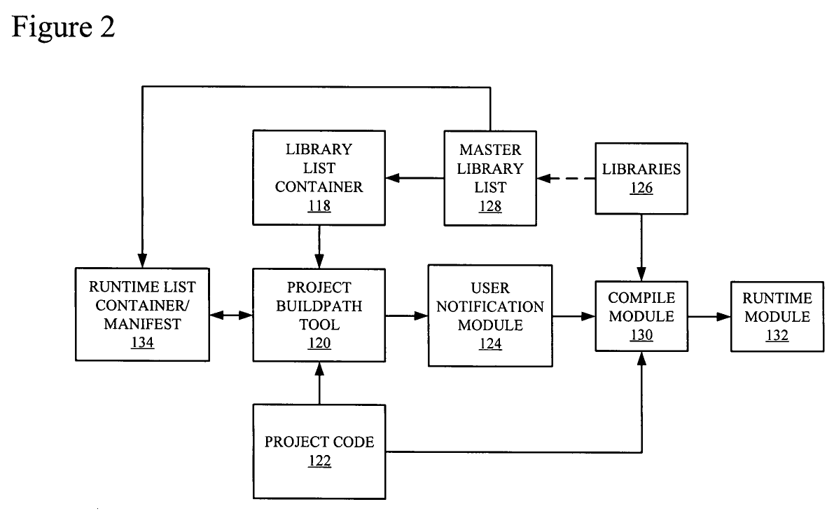

FIG. 2 is a block diagram of a project buildpath tool 120, illustrated in conjunction with other development environment components described below. Project buildpath tool 120 takes input from a library list container 118, a runtime container/manifest 134 and a project code module 122. Container 118 is typically created by a developer to correspond to a particular project but may correspond to several projects. In other words, there may be 1:1, a 1:N or an N:1 relationship among containers, such as container 118, and corresponding projects or applications. As a project is created, the developer lists any libraries that the developer believes might be required for the project. In addition to a list of available libraries, container 118 includes some information about the listed libraries such as, but not limited to, the classes included in each library and any dependencies a particular library or class may have upon other libraries.

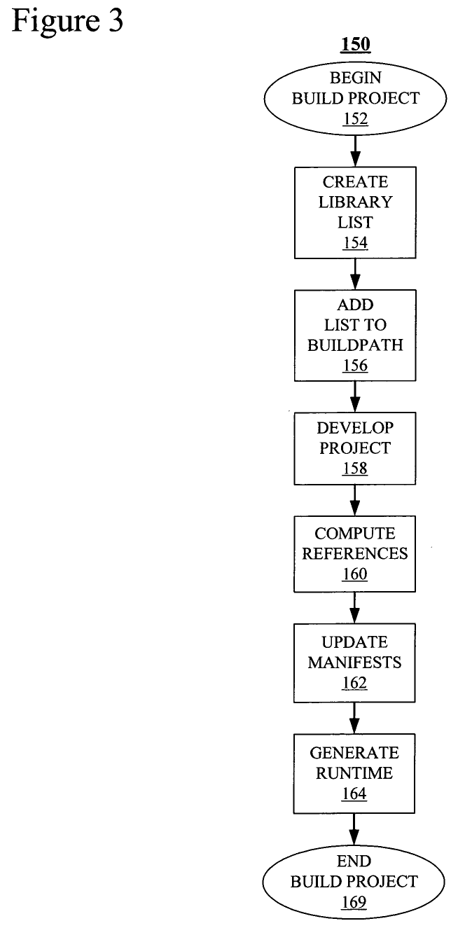

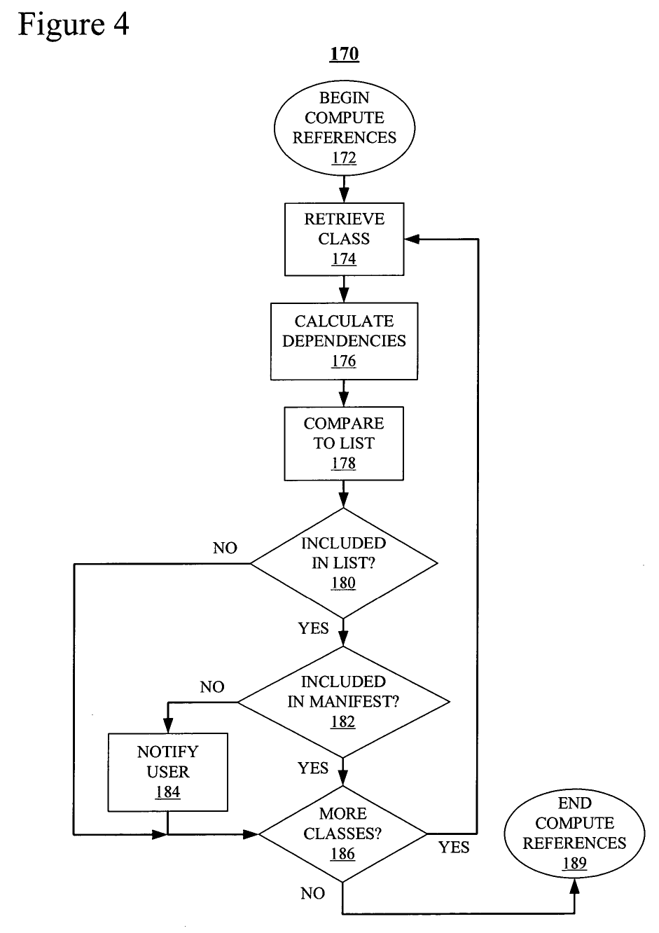

In one embodiment, a master library list 128 is created that contains all the relevant information about any available library 126. The developer then selects libraries from master library list 128 for inclusion in library list container 118. Those with skill in the computing arts should understand how to implement such a master list and selection mechanism. For example, a graphical user interface (GUI), may be provided to facilitate the selection of libraries for inclusion in library list container 118. The use of library list container 118 and runtime list container/manifest 134 are described in more detail below in conjunction with FIGS. 3 and 4.

As explained above, library list container 118 includes entries selected by the developer from master library list 128, which is based upon available libraries in a library storage area 126. An example process of project buildpath tool 120 is described in more detail below in conjunction with FIG. 3.

Project code module 122 represents code created by a developer for a particular project. In this example project code 122 includes bundles 110 and 112 (FIG. 1). Project buildpath tool 120 typically access project code 122 either when the developer saves files created for the particular project or prior to a compilation of the files into an executable file.

Project buildpath tool 120 determines from an examination of the classes included in project code 122 whether or not any libraries necessary for the compilation and functioning of each class is listed in library list container 118 and missing from runtime list container/manifest 134. In a user notification module 124, the developer is notified if any necessary libraries are missing from runtime list 134 but present in library list 118. If so, the developer modifies runtime list container 134 to include the corresponding library and project buildpath tool 120 executes another check. Even though the developer may include a particular library identified in the first iteration, the included library may have dependencies that are identified in subsequent iterations. In the alternative, once project buildpath tool 120 may automatically include any identified, needed library references in runtime list container 134 found in library list 118. In this case, user notification module 124 signals the user that identified libraries have been included in runtime list container 134.

A compile module 130 converts project code 122 into a runtime module 132, using classes from library 126 that are reference in now-modified runtime list container/manifest 134. Runtime module 132 also includes a bundle manifest with the proper dependencies from Runtime list container 134. In this manner, the developer does not need to calculate the exact set of library dependencies for runtime module 132. Rather, the developer only needs to list potential libraries and project buildpath tool 120 ensures that each library included in the buildpath and the corresponding manifest, in this example manifests 114 and 116, is necessary for runtime module 132.

FIG. 3 is a flow chart of an exemplary Build Project process 150 that employs the claimed subject matter. Process 150 starts in a “Begin Build Project” block 152 and control proceeds immediately to a “Create Library List” block 154 during which a developer, either manually or via a GUI, creates a list of potential libraries that may be included in a particular project. In this example, the list corresponds to library list container 118 (FIG. 2). As mentioned above in conjunction with FIG. 2, container 118 may also include information about the listed libraries such as, but not limited to, the classes included in each library and any dependencies a particular library or class may have upon other libraries.

During an “Add List to Buildpath” block 156, tool 120 automatically adds references to the libraries selected during block 154 and stored in container 118 to the project buildpath. It should be understood, that, when a project is first created, the references to some libraries may automatically be added to the project's buildpath.

During a “Develop Project” block 158, the developer generates code that represents a particular computing product. In this example, the code may include bundles 110 and 112 (FIG. 1). During block 158 the developer does not need to be concerned with any library dependencies that the code may have. Of course, if the developer determines that there is a particular dependency, then the developer adds a reference to the corresponding library to container 118. In other words, blocks 154 and 156 may occur either concurrently or separately in no particular order.

During a “Compute References” block 160, project buildpath tool 120 (FIG. 2) examines the generate project code to determine any library dependencies. If tool 120 determines that a library dependency exists, and this library is listed in library list container 118, but not in Runtime list container/Manifest 134, then it is a missing dependency. Block 160 is described in more detail below in conjunction with FIG. 4.

Once Compute Reference block 160 finds any missing dependencies an “Update Manifests” block 162, adds the dependencies to Runtime list container/Manifest 134. During a “Generate Runtime” block 164, process 150 employs the manifests updated during block 162 to create a computer executable module corresponding to bundles 110 and 112 and the corresponding manifests. Finally, process 150 is complete in an “End Build Project” block 169.

The claimed subject matter enables the developer to generate a computer executable module without the need for excessive attention to code dependencies. Further, the computer executable module generated in accordance with the claimed subject matter does not include unnecessary library code.

FIG. 4 is a flow chart of an exemplary Update Manifest process 170, which is a portion of Build Project process 150 introduced in conjunction with FIG. 3. Process 170 loosely corresponds to Compute References block 160 (FIG. 3) and Update Manifest block 162(FIG. 3). Process 170 is typically executed after a user has saved project code 122 (FIG. 2) and indicated a desire to initiate process 170. This desire can be indicated by executing a corresponding program or incorporated into the save operation such that the user can click on a button in a GUI during a save operation.

Process starts in a “Begin Compute References” block 172 and control proceeds immediately to a “Retrieve Class” block 174 during which process 170 scans, in this example, project code 122 (FIG. 2) for programmed class objects. Once process 170 detects a class object, the detected object is, during a “Calculate Dependencies” block 176, examined for any library dependencies or references. Calculate dependencies block may even be recursive in that any particular object that is identified as a necessary element may also have its own dependencies.

During a “Compare to List” block 178, library references in library list container 118 (FIG. 2) are compared to libraries that include the necessary elements identified during block 176. During an “Included in List?” block 180, process 170 determines whether or not the library associated with the element or elements (in the case of a recursive element identification process) identified during block 176 are represented by an entry in library list container 118. If not, then process 170 continues to a “More Classes?” block 186, explained below. If so, process 170 continues to an “Included in Manifest?” block 182 during which process 170 checks to see whether or not the necessary library will be available at runtime by analyzing manifest 134 (FIG. 2).

If the dependency is already accounted for in manifest 134 and thus available at runtime, process 170 continues to More Classes? block 186. Otherwise, process 170 notifies the appropriate user during a “Notify User” block 182. During block 182, the developer is notified that an unresolved dependency exists. At that point, the developer takes steps to resolve the deficiency. For example, the developer may add an appropriate entry to manifest/runtime list 134 or modify project code 122 to remove the element with the dependency. If process 170 is executing during a test build, then the developer may decide to proceed without resolving the deficiency with the intention of resolving it later.

During More Classes? block 186, process 170 determines whether or not there are more classes in project code 122 that need to be examined. If so, control returns to Retrieve Class block 174 and processing continues as described above. If all the classes in project code 122 have been examined for dependencies, then control proceeds to an “End Compute References” block 189 in which process 170 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for developing a computer executable module, the computer executable module accessing one or more packages of executable code, the method comprising:
storing a reference to one or more libraries into a project library list, wherein each library contains a plurality of packages of computer executable code;
determining if a package corresponding to a package reference associated with the library reference is used by the computer executable module;
appending a library reference in the project library list to a project buildpath to make the library available for development; and
adding the package reference to a bundle manifest for the computer executable module if the package corresponding to the package reference is used by the computer executable module.

2. The method of claim 1, further comprising:
providing notification that the package corresponding to the package reference is used by the computer executable module; and
wherein the package reference is added to the bundle manifest in response to a request that results from the notification.

3. The method of claim 1, wherein the package reference is automatically added to the bundle manifest upon a determination that the package corresponding to a package reference associated with the library reference is used by the computer executable module.

4. The method claim 1, wherein a bundle associated with the bundle manifest is an OSGi bundle.

5. The method of claim 1, wherein the project library list is an OSGi container.

6. The method of claim 1, wherein the determining if a package is used by the computer executable module is recursive.

7. The method of claim 1, further comprising generating the executable module based upon the bundle and the bundle manifest.

8. A tool for developing a computer executable module, the computer executable module accessing one or more packages of executable code, the tool comprising:
a project library list that includes a plurality of references to one or more libraries, wherein each library contains a plurality of packages of computer executable code;
logic for determining if a package corresponding to a package reference associated with the library reference is used by the computer executable module;
logic for appending a library reference in the project library list to a project buildpath to make the library available for development; and
logic for adding the package reference to a bundle manifest for the computer executable module if the package corresponding to the package reference is used by the computer executable module.

9. The tool of claim 8, further comprising:
logic for providing notification that the package corresponding to the package reference is used by the computer executable module; and
logic for adding the package reference to the bundle manifest in response to a request that results from the notification.

10. The tool of claim 8, wherein the package reference is automatically added to the bundle manifest upon a determination that the package corresponding to a package reference associated with the library reference is used by the computer executable module.

11. The tool claim 8, wherein a bundle associated with the bundle manifest is an OSGi bundle.

12. The tool of claim 8, wherein the project library list is an OSGi container.

13. The tool of claim 8, wherein the logic for determining if a package is used by the computer executable module is recursive.

14. The tool of claim 8, further comprising logic for generating the executable module based upon the bundle and the bundle manifest.

15. A computer programming product for developing a computer executable module, the computer executable module accessing one or more packages of executable code, the tool comprising:
a memory,
a project library list, stored on the memory, that includes a plurality of references to one or more libraries, wherein each library contains a plurality of packages of computer executable code;
logic, stored on the memory, for determining if a package corresponding to a package reference associated with the library reference is used by the computer executable module;
logic, stored on the memory, for appending a library reference in the project library list to a project buildpath to make the library available for development; and
logic, stored on the memory, for adding the package reference to a bundle manifest for the computer executable module if the package corresponding to the package reference is used by the computer executable module.

16. The computer programming product of claim 15, further comprising:
logic, stored on the memory, for providing notification that the package corresponding to the package reference is used by the computer executable module; and
logic, stored on the memory, for adding the package reference to the bundle manifest in response to a request that results from the notification.

17. The computer programming product of claim 15, wherein the package reference is automatically added to the bundle manifest upon a determination that the package corresponding to a package reference associated with the library reference is used by the computer executable module.

18. The computer programming product claim 15, wherein a bundle associated with the bundle manifest is an OSGi bundle.

19. The computer programming product of claim 15, wherein the logic for determining if a package is used by the computer executable module is recursive.

20. The computer programming product of claim 15, further comprising logic, stored on the memory, for generating the executable module based upon the bundle and the bundle manifest.
